(19) United States
(12) Patent Application Publication
(10) Pub. No.: US 2006/0020512 A1
(43) Pub. Date: Jan. 26, 2006

(54) Manufacturer promotion automation system and methods

(76) Inventors: Michael T. Lucas, Calabasas, CA (US); Venkata Ramana Pinnam, Madison, WI (US)

Correspondence Address: NATH & ASSOCIATES, PLLC, Sixth Floor, 1030 15th Street, N.W., Washington, DC, 20005, US

(21) Appl. No.: 11/153,849

(22) Filed: Jun. 16, 2005

Related U.S. Application Data
(63) Continuation-in-part of application No. 09/799,879, filed on Mar. 7, 2001.
(60) Provisional application No. 60/187,389, filed on Mar. 7, 2000.
(60) Provisional application No. 60/579,814, filed on Jun. 16, 2004.

(51) Int. Cl. G06Q 30/00

(52) U.S. Cl. 705/14

(57) ABSTRACT

The inventive subject matter relates to systems and methods for monitoring retail sales and automatically correlating sold products with manufacturer sponsored or approved promotions presented for redemption by customers.

This application is a Continuation-in-part of U.S. patent application Ser. No. 09/799,879, filed Mar. 7, 2001, which in turn claims priority to, and the benefit of, U.S. Provisional Patent Application No. 60/187,389, filed Mar. 7, 2000; and additionally claims priority to, and the benefit of, U.S. Provisional Patent Application No. 60/579,814, filed Jun. 16, 2004, the contents of which are hereby incorporated by reference herein in their entirety.

### BACKGROUND OF THE INVENTIVE SUBJECT MATTER

1. Field of the Inventive Subject Matter

The inventive subject matter relates to systems and methods for monitoring retail sales and automatically correlating sold products with manufacturer sponsored or approved promotions presented for redemption by customers.

2. Background

The present inventive subject matter relates generally to systems for providing incentives to customers to shop in retail stores and, more particularly, to systems for automatically delivering and accounting for customer coupons, rebates, and other incentives via a computer network.

Producers of food, drugs, mass merchandising items and related products in the packaged goods industry use various marketing techniques to encourage consumer purchases and establish brand loyalty. Two of the most commonly used purchase incentives are the rebate offer and the discount coupon. Both of these purchase incentive media, under current systems, present significant problems in distribution, fulfillment, redemption, and accounting.

From the consumer's perspective, traditional incentive programs systems suffer drawbacks in terms of convenience of tracking data, changing promotions, and the like. For example, for a consumer who participates in multiple incentive programs it may take time and effort to track his or her participation in each program. For example, time is required to keep track of loyalty points earned in each separate incentive program. Therefore, when a consumer receives an offer to participate in an incentive program, the consumer may decide against participating in it, not because the incentive program is not attractive, but because the cost to the consumer, in terms of the time and effort to tracking another incentive program, exceeds the expected benefit of the incentive program. Accordingly, a need exists for a streamlined system and method for simplifying consumer participation in incentive programs.

A similar problem exists for sponsoring companies, which are usually manufacturers, but may be distributors or even retailers, who wish to offer promotions. The collective costs of generating incentive programs, administering the incentive programs, tracking the participation of consumers in the incentive programs and fulfilling the awards or prizes won in such incentive programs may exceed the benefits of offering the incentive program. These costs may be particularly high in instances where the activities associated with an incentive program must be carried out by different companies, or by different organizations within the same company. Accordingly, a need exists for a unified system that provides for program generation, administration, data tracking, award fulfillment, and accounting.

Existing incentive programs do not meet all of the consumer and sponsor needs associated with incentive programs.

One form of incentive program that is used extensively is that of promotional mailings. The processing of promotions, i.e., providing the appropriate check or discount coupon to the customer as a reward for the initial purchase, involves high volume and labor intensive activity, including collection, verification and organization of initial proofs of purchase and related information, preparation of the checks, coupons or other items in connection with a particular promotion, and finally the sorting and other handling of individual coupons or forms.

At any given time, a typical third party processor of promotion services is involved with many different promotions of various sponsoring manufacturers. Preprinted forms, when provided by different sponsors, can vary in size and shape, thus creating the need to handle individual promotions separately. From the perspective of third party processors of incentives, this increases handling expense, not only in added labor, but also in the mailing cost, as it is difficult with a single promotion to accumulate a volume of items sufficient to qualify for certain reduced postage rates, e.g. the reduced rate available for mail presorted by zip code of the destination. Manual recombination and sorting of items for multiple promotions would be prohibitively expensive.

The general state of the art relating consumer incentive redemption and accounting is described in the following U.S. Patents and related discussion.

Coupon redemption programs. One approach widely used to deliver purchasing incentives is in the form of printed discount coupons provided, through various channels, to customers of retail stores.

Coupons have been distributed to customers by mail, either in a random manner or in a more or less demographically focused manner. Coupons have also been delivered to customers in retail stores, from store displays, in kiosks, or at the check-out stand in response to the customer's purchase of some preselected item or items. The latter technique is disclosed, e.g., in U.S. Pat. No. 4,723,212, “Method and Apparatus for Dispensing Discount Coupons.”

Regarding coupons as purchase incentives, a brief description of the current coupon distribution and redemption system and the prior art developments in that area will indicate further advantages of the present inventive subject matter as a method for effecting purchase reward offers. Typically, coupons are distributed to the public through newspapers, magazines and direct mail. The consumer clips the coupon from the publication and presents it when purchasing items at the check-out counter of a retail store. At least in theory, the check-out clerk inspects the coupon to ensure that all the conditions for its redemption are met. A typical condition for redemption is the purchase of a specified item before a specified expiration date. If the coupon is validly presented, the clerk deducts the coupon value from the consumer's bill.

In the reimbursement process, retail store personnel periodically gather all redeemed coupons, sort them according to manufacturer, and tally the individual totals for reimbursement. The calculated figures and coupon groupings are usually audited by a coupon clearinghouse which then sends them onto the manufacturers. The manufacturers then reimburse the retail store for the redeemed coupons plus a standard handling charge.

Through the years, coupon issuers have experienced many problems with the coupon distribution and redemption system. For example, in the area of distribution, manufacturers have found that not all consumers will go through all the steps necessary to redeem their coupons. Commonly, in addition to consumers that simply don't bother with the time and effort to clip coupons, other consumers simply forget to bring to the store the coupons that they have clipped and saved.

This consumer behavior defeats the purpose for offering a purchase incentive. A manufacturer distributes coupons with the expectation that the coupons will induce sales of its product by offering a discount. However, when the coupon is forgotten or disregarded, the consumer is usually not aware of the incentive when he is selecting a product among different brands at the retail store.

Of course, not all consumers forego the benefit of coupons. In fact, some bring several coupons to the retail store to take advantage of another weakness of the coupon system. Because the verification of redemption conditions is performed by a check-out clerk, a consumer can sometimes overwhelm the clerk by presenting so many coupons that it is impractical to verify the required purchases for all of them. Typically, the check-out clerk does not have the time to verify that the consumer has bought the correct size or quantity of the correct brand for each of a dozen coupons. As a result, some coupons are mis-redeemed without the required purchase.

Similarly, the auditing and reimbursement stages of the coupon system also present several problems. First, unscrupulous persons can use deficiencies in the coupon system to fraudulently submit unredeemed coupons to the manufacturers for reimbursement. For example, it is believed that some retail store personnel have purchased large quantities of unredeemed coupons from collectors at prices below their face value, and then returned these coupons to the manufacturers for reimbursement at full face value. Although this practice is sometimes used to reap large profits, it is commonly used on a smaller scale to cover shrinkage losses of the retail store. Nevertheless, it is believed that these fraudulent practices cost manufacturers millions of dollars a year.

Another source of trouble in the coupon system is the coupon clearinghouse. While both the manufacturer and the retail stores rely on the coupon clearinghouse to impartially verify the tallied figures for coupon reimbursement, the volume of coupons audited often requires the clearinghouse to use cheap, unskilled labor, often resulting in erroneous totals.

In the prior art, several methods have been devised to alleviate problems in the coupon system. With the integration of computer systems into the packaged goods industry, there have been a number of attempts to combat the problems in the coupon system through application of available computer technology.

Equipment used to read machine-readable codes, such as the Universal Product Code (UPC) bar-code, was first designed to improve inventory control and checkout efficiency. See, e.g., U.S. Pat. No. 3,959,624 to Kaslow et al., which discloses the use of machine-readable codes on coupons. Coupons bar-coded with the UPC can be read accurately by scanning equipment. The information picked up from the coupon is compared with stored information read from the bar-codes of purchased products. The controlling computer system can determine the validity of the coupon redemption and either allow or inhibit a discount accordingly. Thus, the losses associated with a check-out clerk's failure to verify satisfaction of coupon conditions can be avoided.

In addition, the Kaslow et al. system can store records of the manufacturer names and discount amounts of redeemed coupons to be used later for coupon auditing and reimbursement purposes. With these computer generated totals, the problems associated with fraud and clearinghouse auditing errors may be somewhat reduced.

In the area of coupon distribution, U.S. Pat. No. 4,554,446 to Murphy et al. reveals two purchase incentive techniques employing computer systems. In the first method, a computerized printer produces machine readable coupons at the supermarket so that a consumer does not have to remember to bring them. The system can be controlled by store personnel or adapted to receive selections from the consumer directly. Moreover, Murphy et al. suggests the use of machine-readable customer identification cards to limit those consumers eligible to obtain the computer-generated coupons.

A second computer-based purchase incentive method disclosed by Murphy et al. relates to so-called self-liquidating premiums. A self-liquidating premium is essentially an offer from a manufacturer to consumers who purchase a particular product to buy a different product at a substantial savings. Because the premium is offered to entice purchases of the required product, the premium product is usually offered at a break-even price; hence, it is self-liquidating.

In order to take advantage of a premium offer, a consumer buys a specified product. The advertisement for the premium product is usually on the package of the required product. Under the typical method, the consumer must then send the manufacturer some proof of purchase and the premium purchase price. These items are usually sent by mail from the consumer's home.

Murphy et al. discloses a computer system for generating machine-readable sales vouchers to order the premium product at the retail store. The store computer stores files related to the premium offers. When a consumer makes the required purchase, he presents the sales voucher and the payment of the premium purchase price. The store computer records the transaction so that the retail store can order the premium product directly for the consumer. The retail store becomes a point of purchase for premium products, making the offer more convenient for the consumer and thereby increasing the incentive value of the premium offer.

Another coupon distribution technique utilizing a computer system is disclosed in U.S. Pat. No. 4,723,212 to Mindrum et al. Recognizing that a manufacturer desires to distribute coupons to consumers who purchase a competitor's products, Mindrum et al. teaches a system for generating a machine-readable coupon for a product when the bar-code of a competitive product is read by the check-out terminal scanner. Hence, the manufacturer is able to distribute a coupon directly to the consumer it is targeting, a customer of the competition.

Another system exists in the prior art which uses a computer system to offer purchase incentives without distributing coupons. In the system, the consumer is issued a customer identification card with an encoded consumer identification code in machine-readable format. A list of products subject to discounts is distributed at the retail store. When a valid identification card is scanned at the check-out terminal, the store computer automatically discounts those items on the list according to stored product files.

Each prior art system discussed above addresses some of the problems related to the coupon distribution and redemption system. However, the prior art devices and methods focus on isolated coupon transactions requiring customer registration for electronic incentives or the handling of paper coupons. The prior art does not address the privacy concerns of consumers, nor the costs and efforts of handling paper. Accordingly, it is an object of the inventive subject matter to provide a method for encouraging continued purchases of targeted products beyond the one-time incentive of prior coupon systems.

A system, preferably computer-aided or executed, that provides automatic processing of a rebate on a product is disclosed. The system includes a rebate processing center communicating over a network with a manufacturer, a retailer, and optionally a distributor, a third party processor, or both. The rebate processing center maintains a promotion table and a transaction table in order to facilitate processing and accounting of product rebates and to offer the consumer an on-the-spot incentive redemption and credit, without the requirement for registration or handling of any paper documents. Of course, as discussed herein, in alternate embodiments the inventive subject matter comprises automatically processing and accounting for incentive programs, between the source granting the incentive and the retailer, even if the retailer elects to continue using membership clubs, paper coupons, rebate forms, or a combination thereof.

Rebate Programs. The consumer rebate is a ubiquitous marketing tool employed by companies selling goods at virtually all price levels. For example, rebates for relatively expensive goods such as consumer electronic equipment may be in the range of twenty dollars and up, yet most consumer rebates are for grocery and domestic items and are in the range of twenty five cents to two or three dollars. Thus, handling and transaction costs can be a significant cost factor in relation to the cost of the rebates themselves for most rebate programs.

Regarding rebate programs, the rebate offer essentially offers a refund from the manufacturer to the consumer for the purchase of a specified quantity of a particular product. Because the rebate offer often requires the purchase of more than one of the rebated product, it serves as an enticement for the consumer to continue purchasing the rebated product. This multiple purchase requirement has more potential for developing sales volume and brand loyalty than incentives, such as the discount coupon, which encourage the one-time purchase of a product. However, the incentive created by rebate offers is diminished by the inconvenience in fulfilling offer requirements and the unreliable nature of the redemption process. These shortcomings reduce the value of the rebate offer to both the consumer and the manufacturer.

In this regard, the consumer is typically required to save proofs-of-purchase from product packaging and mail them with an associated offer form to the manufacturer to earn the rebate. Many consumers find it too inconvenient to remember to remove the proofs-of-purchase from products purchased over an extended period of time and save them with the associated form. Additionally, the postage for mailing the proofs of purchase diminishes the value of the rebate to the consumer.

Another disadvantage of the current rebate system is that some consumers from different households pool their proofs-of-purchase to submit for rebate. Although this practice results in quicker rebate redemptions for these consumers, it defeats the purpose of the manufacturer for offering multiple purchase rebates. Consumers engaging in this practice will likely switch brands to take advantage of other rebate offers when, together, each participating consumer has to purchase only one of the rebated products.

When a consumer does perform the necessary steps to receive a rebate, he must typically wait several weeks to receive the rebate from the manufacturer. In addition, manufacturers often delegate rebate redemption processing to coupon clearinghouses. These clearinghouses often use unskilled labor to process coupons and rebates in large volumes. As a result, a substantial percentage of redemption requests are lost or improperly processed.

In view of the inconvenience and lack of reliability for a consumer who furnishes the necessary documents to the manufacturer to receive a rebate, it is still another object of the inventive subject matter to provide a system that automatically a purchase incentive without the mailing requirements of traditional rebate programs.

In addition, the cost to the manufacturer of processing consumer rebates relative to their cash value to the consumer is problematic. Manufacturers must provide rebate request intake services, must manually check that the rebate request includes the proper coupon, proof-of-purchase and receipt, and must process the check and mail it to the consumer with prepaid postage. Checks for small amounts are often not even cashed by the consumer, which itself causes accounting problems. Although rebate service clearinghouses exist which can perform these tasks, the costs to the manufacturer still exist and are ultimately absorbed by the consumers.

Further, as discussed above, the consumer often does not take advantage of the rebate since the time required in obtaining and filling out the coupon, cutting off the package label, and looking for the cash register receipt is simply not worth the effort for the promise of a twenty five or fifty cent check to be received in some four to eight weeks. The consumer may as a result become disenchanted with the goods offered with rebates and opt for goods which are simply less expensive at the point-of-sale. Thus, the positive marketing effect sought by rebate offers is obviated by the cumbersome rebate process itself.

Systems have been proposed in the prior art in an attempt to automate the rebate and coupon industry and relieve some of the aforementioned problems. For example, membership club or loyalty programs, which use a computer system to offer purchase incentives without distributing coupons, have been offered as a partial solution to the deficiencies in the manufacturer promotion/incentive industry. In such a system, the consumer is issued a identification card with an encoded consumer identification code in machine-readable form. A list of products subject to discounts is distributed at the retail store. When a valid identification card is scanned at the check-out terminal, the store computer automatically discounts those items on the list according to stored product files. This system requires the use of specially issued consumer identification cards, and those consumers without such cards cannot participate in the program. Moreover, this system requires merchants to participate in the program and provide a point-of-sale discount rather than a true manufacturer's rebate.

U.S. Pat. No. 5,056,019 to Schultz et al., describes a similar marketing method for providing manufacturer reward offers by automatically tracking the purchase of member consumers through the use of bar-coded membership cards and using the purchase records in a data processing system to determine if the required purchases have been made to earn a reward. Members receive a reward booklet listing the available reward offers and a periodic status report to track the consumer's individual purchase progress. A reward certificate is issued or a check is issued after a predetermined number of purchases have ben made. Disadvantageously, the system of Schultz et al. thus requires both consumers and merchants to become members to the system. Thus consumers not part of the system cannot receive rebate credit. Moreover, even those consumers who are members of the system will not be ale to obtain rebate credit at non-participating merchants; their choice of shopping outlets is thus limited by the system itself. In addition, special card reading equipment at the point of sale is required. Moreover, the system does not provide a substantially immediate rebate to the consumer subsequent to the purchase of the products.

U.S. Pat. No. 5,202,826 to McCarthy, discloses a centralized system of accumulating credits for consumers based upon point-of-sale transactions with multiple merchants wherein for each transaction, the consumer's preassigned account number is transmitted to the central system along with data identifying the merchant and the credit value for that transaction. The credit value may be selected by the merchant or may be established by the presentment by the consumer of a manufacturer's rebate coupon. An account dedicated for each consumer is revised after each transaction, and at some predetermined time, the consumer is given access to his total credits by either an electronic funds transfer to an existing bank account or by the issuance of a check to the consumer through the mail. The system of McCarthy only partially dispenses with the need for paper processing of rebates, since the consumer without an appropriate bank account will still require the issuance of a check in order to collect his funds. Moreover, the consumer in McCarthy's system must wait until a predetermined time has occurred in order to collect, which may be up to one year from the time the purchase was made. Further, the system of McCarthy requires the merchants to participate, thus preventing the consumer from obtaining rebate credit at a non-participating merchant. Moreover, participating merchants must purchase and install special computers and communications devices adding undesirably to the cost of implementation of the system.

Other incentive programs. Computer incentive programs are offered on the Internet; however, such systems are generally offered by a single sponsor and are generally limited to offering consumers the ability to participate in incentive programs. Known systems do not offer sponsors the ability to conveniently generate incentive programs, to track participation of consumers in multiple incentive programs, or to provide for automated fulfillment of awards.

The introduction of the digital computer and the computer network eliminates some of the inconveniences of conventional incentive programs, particularly those that relate to data tracking and manipulation. The digital computer is a powerful data processing tool that allows a user to organize, store and analyze data at volumes and rates that would be impossible by any prior known techniques.

Computers have been used in connection with incentive programs and other programs that have characteristics in common with incentive programs, but known computer incentive programs address some, but not all of the drawbacks of traditional promotions. For example, U.S. Pat. No. 5,053,955 to Peach et al. discloses an improved process of printing and assembling coupons. Peach et al. discloses a computer-based system for merging certain information for various promotions, so that a single stream of data can be used as a source for printing and mailing coupons for multiple promotions. Thus, the system of Peach et al. reduces some of the paperwork associated with a single-promotion systems, but it merely mitigates, rather than solves, the problems inherent in paper-based promotions.

Computer-based promotional games are also known. Such games include scratch-and-win games, treasure hunts, video pinball and the like. Such incentive programs have advantages over paper promotions, in that data regarding participation is easily stored and manipulated. However, existing incentive programs do not solve all consumer and sponsor needs. In particular, such promotional games do not assist consumers in tracking participation in multiple promotions and do not assist sponsors in generating incentive programs, tracking participation in incentive programs and fulfilling awards and prizes.

Computer-based systems exist for tracking some aspects of consumer participation in incentive programs. For example, U.S. Pat. No. 5,056,019 to Schultz et al. discloses an automated purchase reward accounting system and method. In particular, Schultz et al. discloses a marketing method for providing manufacturer purchase reward offers by automatically tracking the purchases of member consumers through the use of bar-coded membership cards and using the purchase records in a data processing system to determine if the required purchases have been made to earn a reward. Each member consumer receives a reward booklet disclosing the available reward offers, a periodic status report indicating the member consumer's progress toward earning rewards, and a reward certificate for those rewards earned. The card-based system of Schultz takes advantage of certain data processing capabilities of computer systems and certain data storage capabilities of electronic card technologies; however, among other drawbacks, the system of Schultz does not address the need for a system that assists sponsor companies in generating incentive programs, in tracking participation of consumers in multiple incentive programs, or in fulfilling awards.

The computer network offers the possibility of improved systems for offering incentive programs and for tracking participation in an incentive program. By linking together several computers and by providing shared resources and cross-platform communications, the computer network provides improved access to sophisticated applications by users at remote locations.

One of the most widely accepted and heavily used networks is the Internet. The Internet is a global system of interconnected computer networks formed into a single world wide network. A user, through the Internet, can interactively transmit messages with users in different countries. Similarly, a user in the U.S. connected to files and libraries and other jurisdictions such as Europe and Asia, can download files for personal use. Accordingly, the Internet computer network provides strong communications functions similar to the communications functions provided by ham radio operators. Moreover, the Internet computer network acts like a universal library, providing electronic access to resources and information available from Internet sites throughout the world.

Various systems and methods are known which permit a sponsor to track data of multiple parties in databases and to update information in the databases based on transactions entered into by the parties to the transactions. For example, U.S. Pat. No. 5,664,115 to Fraser discloses an interactive computer system to match buyers and sellers of real estate using the Internet. Similarly, banks, credit card companies, and other financial institutions have developed computer-based systems that track client account information and update the information upon entry of various transactions. Some such systems involve use of electronic cards and operate over computer networks. Such systems have requirements peculiar to their respective industries, and none of the existing systems address all of the problems inherent in known incentive programs, particularly the problem of the need for an incentive program system that conveniently tracks participation while offering automated generation of incentive programs and automated fulfillment of awards won in incentive programs.

An important drawback of known computer incentive program systems is that the obligation to fulfill the awards promised in a promotional campaign is often a logistically difficult and expensive task. The coordination of delivering or arranging for the retrieval of the awards for the specified winner, in volumes that permit successful incentive programs, requires coordination of prize inventory, systems and information.

One system that addresses award fulfillment is disclosed in U.S. Pat. No. 5,025,372 to Burton, et al. Burton et al. discloses a system and method for administration of incentive award programs through letters of credit. In the Burton et al. system, a computer system for an incentive award program allocates monetary amounts available for expenditure through credit instruments issued to program participants when the participants perform to a designated level of achievement. Participants' identifying information and credit instrument account numbers are stored in memory. Levels of performance are calculated and assigned for each participant in order for a monetary amount to be available for expenditure through the participant's credit instrument. Calculations, adjustment and reporting concerning amounts allocated for instrument use, withheld amounts, instrument transactions and account balances are made. Calculations and printed invoices for payment by a financial institution to an incentive company based on the credit instruments issued under the incentive program are made and are dependent upon the monetary volume of expenditures through the credit instruments, the total interest income on the credit instruments, and the number of instruments issued.

The system of Burton et al. takes some advantage of a computer system for tracking data, but it has a number of drawbacks. Among other things, Burton et al. offers no advantage to a company sponsoring an incentive program in terms of the investment of skill and labor in developing an incentive program. Further, the complex letter of credit scheme of Burton et al. is likely to require participation of other entities, such as banks and attorneys in order for it to operate properly. Also, Burton et al. does not provide for tracking of data for participation of a given consumer in incentive programs of multiple program providers. Finally, Burton et al. does not provide a system for automated generation of incentive programs.

Thus, an increasing number of retail store customers also owning personal computers and having access to computer network services that provide connections to the Internet and the World Wide Web. Although some computer sites connected to the World Wide Web have begun to offer “online” shopping services, and some services have proposed to deliver discount coupons through a computer network, the full potential of online handling of incentives has not been realized prior to the present inventive subject matter.

Similarly, marketing methods for providing manufacturer purchase reward offers by automatically tracking the purchases of member consumers through the use, for example, of bar-coded membership cards, and using the purchase records in a data processing system to determine if the required purchases have been made to earn a reward. However, such membership reward programs still require consumer registration, and have consumer, manufacturer, and retailer record-keeping requirements.

It is therefore an object of the inventive subject matter to overcome the problems of the prior art and to provide a system and method which will allow a consumer of goods to instantly apply a rebate, coupon discount, or other incentive promotion without the necessity of tending to the above-mentioned paperwork.

It is a further object of the inventive subject matter to provide a system which, after initial set-up, will automatically provide a rebate to the consumer without the need for manufacturer intervention on a request-by-request basis.

It is a further object of the inventive subject matter to provide a system which can be implemented within the framework of a platform accessible to manufacturers, suppliers and distributors, retailers, and optionally third parties acting on their behalf or system administrators, so as to reduce the cost of implementation and make the system available to at least retailers and manufacturers.

It is a still further object of the inventive subject matter to provide a system which does not require intervention or participation by the retail merchant at the point-of-sale, thus allowing the consumer to shop at the merchant of choice and thus reducing the cost of implementation of the system.

Finally, it is an object of the inventive subject matter to provide a system which automatically tracks, calculates, and issues payment authorizations to retailers, and thus reducing the cost of implementation of the system.

### SUMMARY OF THE INVENTIVE SUBJECT MATTER

The inventive subject matter relates to a method for monitoring retail sales and automatically correlating sold products with manufacturer sponsored or approved promotions presented for redemption by customers, comprising the steps of:

(a) creating a promotion incentive program having parameters relating to at least the following:

(i) identity of a product or service to which the promotion incentive is to apply,

(ii) a price reduction amount of the promotion incentive,

(iii) monetary value, percentage discount, or quantity discount of the promotion incentive, and

(iv) an applicable start date, end date, or both of the incentive program;

(b) providing for incentive program participation acceptance by retailers;

(c) monitoring each incentive discount or credit given by each participating retailer;

(d) calculating the monetary value of each incentive discount or credit given by each participating retailer;

(e) calculating the monetary value of incentives discount or credit to the consumer by each retailer for a selected time period; and

(f) authorizing payment to each retailer for the dollar value of incentives discounted or credited to the consumer for the selected time period.

The inventive subject matter specifically relates to a system for monitoring retail sales and automatically correlating sold products with manufacturer sponsored or approved promotions presented for redemption by customers, comprising the steps of:

(a) at the request or suggestion of a retailer, supplier, or distributor, creating a promotion incentive program having parameters relating to at least the following:

(i) identity of a product or service to which the promotion incentive is to apply,

(ii) a price reduction amount of the promotion incentive,

(iii) monetary value, percentage discount, or quantity discount of the promotion incentive, and

(iv) an applicable start date, end date, or both of the incentive program;

(b) providing for incentive program participation acceptance by retailers;

(c) monitoring each incentive discount or credit given by each participating retailer;

(d) calculating the monetary value of each incentive discount or credit given by each participating retailer;

(e) calculating the monetary value of incentives discount or credit to the consumer by each retailer for a selected time period; and

(f) authorizing payment to each retailer for the dollar value of incentives discounted or credited to the consumer for the selected time period.

The inventive subject matter further relates to a system for monitoring retail sales and automatically correlating sold products with manufacturer sponsored or approved promotions presented for redemption by customers, comprising the following elements, operably connected:

(a) at least one computer having at least one storage medium;

(b) one or more databases residing on said at least one storage medium, in which at least the following data is stored:

(1) the identity of a product or service to which the promotion incentive is to apply,

(2) a price reduction amount of the promotion incentive,

(3) the monetary value, percentage discount, or quantity discount of the promotion incentive, and

(4) an applicable start date and end date of the incentive program; and

(c) client software residing on said at least one storage medium providing an interface to said one or more databases(), wherein the client software identifies users and allows users to be classified into groups, and wherein permissions or roles are assigned to such groups, and wherein:

(i) said software permits creation of a promotion incentive program based on said stored data,

(ii) said software provides for incentive program participation acceptance by retailers,

(iii) said software monitors each incentive discount or credit given by each participating retailer,

(iv) said software calculates the monetary value of each incentive discount or credit given by each participating retailer,

(v) said software calculates the monetary value of incentives discount or credit to the consumer by each retailer for a selected time period, and

(vi) said software authorizes payment to each retailer for the dollar value of incentives discounted or credited to the consumer for the selected time period.

### BRIEF DESCRIPTION OF THE DRAWINGS

FIG. 1 is a drawing which depicts functional system components as implemented in a preferred embodiment of the present invention.

FIG. 2 is a drawing which depicts various user types and the functions available thereto in a preferred embodiment of the present invention.

FIG. 3 is a diagram which depicts a use case as implemented in a preferred embodiment of the present invention.

### DETAILED DESCRIPTION OF THE INVENTIVE SUBJECT MATTER

### DEFINITIONS

The term “manufacturer” as used herein refers broadly to both a person or entity engaged in the business of manufacturing a product and to a person or entity engaged in the business of furnishing a service. In relation to the claimed systems and methods, a manufacturer is also the person or entity which bears financial responsibility for the cost for an incentive program. The term “manufacturer” as used herein also includes a person or entity acting on behalf of said manufacturer.

The term “retailer” as used herein refers to a person or entity engaged in the business of the sale of goods or commodities at retail to consumers. The term “retailer” as used herein also includes a person or entity acting on behalf of said retailer.

The terms “supplier” and “distributor” as used herein are interchangeable terms and refer to a person or entity a business engaged in the business of the sale of goods in large quantities for resale. The terms “supplier” and “distributor” as used herein also include a person or entity acting on behalf of said supplier or distributor.

The terms “partner” and “third party processor” as used herein are interchangeable terms and refer to a person or entity which is in the business of administration of incentive programs on behalf of manufacturers.

The present invention preferably includes a web-based application which can be accessed through predefined portals that provides a system and methods for monitoring retail sales and automatically correlating sold products with manufacturer sponsored or approved promotions, thereby reducing the burden on retailers in applying for and receiving credit under such promotions. The system preferably allows manufacturers, retailers, suppliers, and/or partners (such as, but not limited to, a third-party Company who executes manufacturer promotions) to participate in and review the status of manufacturer sponsored promotions via the internet. The system can define, identify, and integrate Partners (manufacturer promotions processing company) and Manufacturers as an integral part of the system for processing retail product promotions.

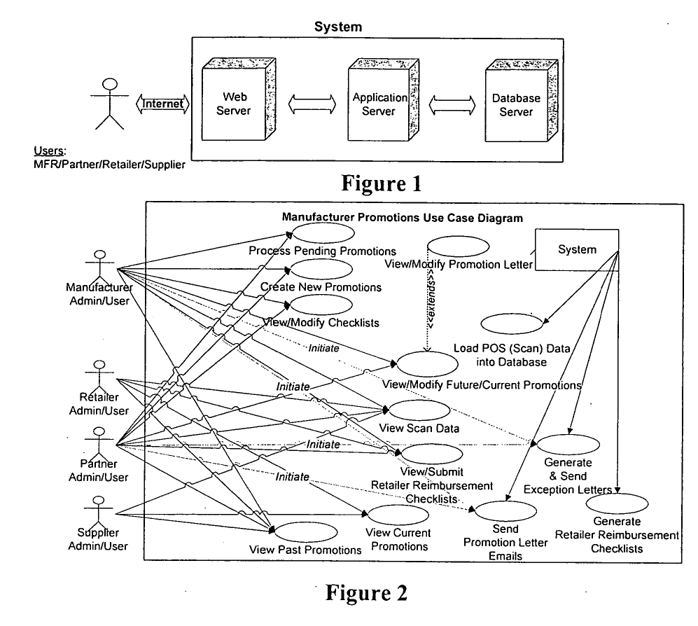

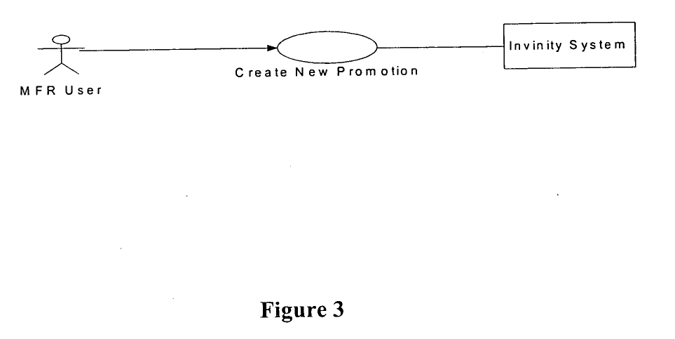

Participating manufacturers are preferably provided with an account to access system through a “Manufacturer” web portal. This portal preferably allows the manufacturers to create new promotions, view/modify existing promotions, process data, track payments, and maintain promotions, and related data using system features. It is presumed but not required that manufacturers will have access to all system features. As shown in the preferred embodiment depicted in FIG. 1, manufacturers may have access to most or all system features, either individually or collectively.

Participating retailers are preferably provided with an account to access the system through a “Retailer” web portal. The retailer web portal preferably allows the retailers to review existing promotions an choose to accept (i.e. participate) or decline existing promotions and related data using system features. Participating retailers should preferably be registered/in-list with manufacturer/partner before they are allowed to participate in promotions and access the related information. The system preferably automatically generates and sends notices, such as E-mails, to participating retailers about new promotions as they are added by manufacturers. The system preferably automatically generates “Retail Reimbursement Checklists” and populates the checklists with any required data. The checklists are then preferably made available to the participating retailers to review and submit to manufacturers for payment. Retailers may also request specific promotions from a manufacturer. As shown in the preferred embodiment depicted in FIG. 1, retailers may have access to some limited system features, either individually or collectively.

Participating suppliers and distributors are preferably provided with an account to access the system through a “Supplier/Distributor” web portal. The supplier/distributor web portal preferably allows suppliers to review existing promotions and related data, and choose to accept or decline participation in such promotions using system features. The system preferably automatically generates and sends E-mails to participating partners about new promotions as they are added by manufacturers. As shown in the preferred embodiment depicted in FIG. 1, suppliers and distributors may have access to some limited system features, either individually or collectively.

Partners are preferably provided with access to the system through a “Partners” web portal. The partners web portal preferably allows partners to review and process promotions, and to process, including accepting and modifying Retail Reimbursement Checklists using system features. Partners are preferably given a plurality of accounts, wherein each account can have different levels of access and privileges. Partners and/or manufacturers can view/modify “Retail Reimbursement Checklists” submitted by retailers. As shown in the preferred embodiment depicted in FIG. 1, partners may have access to some limited system features, either individually or collectively.

System data loading programs preferably process scan data (for promotion products only) received from various participating retailers and populate/update the database to adjust inventory and record scanning activities of each product per each scan with date/time stamp. The system preferably prepares scan data (for promotion products only) and make it available for partners, manufacturers and may be also to connected suppliers through system features/reports.

### Inventive Methods

The inventive subject matter relates to a method for monitoring retail sales and automatically correlating sold products with manufacturer sponsored or approved promotions presented for redemption by customers, comprising the steps of:

(a) creating a promotion incentive program having parameters relating to at least the following:

(i) identity of a product or service to which the promotion incentive is to apply,

(ii) a price reduction amount of the promotion incentive,

(iii) monetary value, percentage discount, or quantity discount of the promotion incentive, and

(iv) an applicable start date, end date, or both of the incentive program;

(b) providing for incentive program participation acceptance by retailers;

(c) monitoring each incentive discount or credit given by each participating retailer;

(d) calculating the monetary value of each incentive discount or credit given by each participating retailer;

(e) calculating the monetary value of incentives discount or credit to the consumer by each retailer for a selected time period; and

(f) authorizing payment to each retailer for the dollar value of incentives discounted or credited to the consumer for the selected time period.

In one aspect of the inventive subject matter, said method comprises the additional step of validating each incentive discount or credit to the consumer by each participating retailer.

In another aspect of the inventive subject matter, said method comprises the additional step of providing for modification, continuation, or extension of an existing incentive program.

In a preferred embodiment, said program modification, continuation, or extension is executed by the manufacturer, an authorized supplier or distributor, or an authorized retailer.

In an additional aspect of the inventive subject matter, said method comprises the additional step of notifying retailers of the existence of said incentive program.

In a further aspect of the inventive subject matter, said method comprises the additional step of providing an event notification, based on said monitoring, to said manufacturer when the inventory of said product is less than a pre-determined target quantity, when said product is out of stock, or when the sales of said product are less than a pre-determined target amount.

In another aspect of the inventive subject matter, said method comprises the additional step of forecasting a quantity of product necessary for said promotion incentive program, and ordering said quantity of product.

In another aspect of the inventive subject matter, said method comprises the additional step of reimbursing each said retailer for the calculated monetary value of incentives discounted or credited to consumers by said retailer.

In a preferred embodiment, said calculated monetary value is reimbursed to said retailer by a method selected from the group consisting of check, electronic funds transfer, and off-invoice credit.

In a further aspect of the inventive subject matter, said method comprises the additional step of collecting and storing information relating to customer purchasing or transaction history.

In a preferred embodiment, said customer purchasing or transaction history is communicated to said manufacturer.

In an additional aspect of the inventive subject matter, said method comprises the additional step of collecting and storing customer personal data relating to the customer for each customer redemption presented.

In a preferred embodiment, said customer personal data is communicated to said manufacturer.

In an alternate aspect of the inventive subject matter, said parameters additionally include identification of retailers eligible to participate in said program.

In an additional alternate aspect of the inventive subject matter, said parameters include identification of a geographic area to which said incentive program will apply.

Finally, in yet another aspect of the inventive subject matter, said parameters additionally include a maximum monetary value or quantity limit for said incentive program.

The inventive subject matter specifically relates to a system for monitoring retail sales and automatically correlating sold products with manufacturer sponsored or approved promotions presented for redemption by customers, comprising the steps of:

(a) at the request or suggestion of a retailer, supplier, or distributor, creating a promotion incentive program having parameters relating to at least the following:

(i) identity of a product or service to which the promotion incentive is to apply,

(ii) a price reduction amount of the promotion incentive,

(iii) monetary value, percentage discount, or quantity discount of the promotion incentive, and

(iv) an applicable start date, end date, or both of the incentive program;

(b) providing for incentive program participation acceptance by retailers;

(c) monitoring each incentive discount or credit given by each participating retailer;

(d) calculating the monetary value of each incentive discount or credit given by each participating retailer;

(e) calculating the monetary value of incentives discount or credit to the consumer by each retailer for a selected time period; and

(f) authorizing payment to each retailer for the dollar value of incentives discounted or credited to the consumer for the selected time period.

### Inventive Systems

The inventive subject matter further relates to a system for monitoring retail sales and automatically correlating sold products with manufacturer sponsored or approved promotions presented for redemption by customers, comprising the following elements, operably connected:

(a) at least one computer having at least one storage medium;

(b) one or more databases residing on said at least one storage medium, in which at least the following data is stored:

(1) the identity of a product or service to which the promotion incentive is to apply,

(2) a price reduction amount of the promotion incentive,

(3) the monetary value, percentage discount, or quantity discount of the promotion incentive, and

(4) an applicable start date and end date of the incentive program; and

(c) client software residing on said at least one storage medium providing an interface to said one or more database(s), wherein the client software identifies users and allows users to be classified into groups, and wherein permissions or roles are assigned to such groups, and wherein:

(i) said software permits creation of a promotion incentive program based on said stored data,

(ii) said software provides for incentive program participation acceptance by retailers,

(iii) said software monitors each incentive discount or credit given by each participating retailer,

(iv) said software calculates the monetary value of each incentive discount or credit given by each participating retailer,

(v) said software calculates the monetary value of incentives discount or credit to the consumer by each retailer for a selected time period, and

(vi) said software authorizes payment to each retailer for the dollar value of incentives discounted or credited to the consumer for the selected time period.

In one aspect of the inventive subject matter, said client software additionally validates each incentive discount or credit to the consumer by each participating retailer.

In another aspect of the inventive subject matter, said client software additionally provides for modification, continuation, or extension of an existing incentive program.

In a preferred embodiment, said program modification, continuation, or extension is executed by the manufacturer, an authorized supplier or distributor, or an authorized retailer. In a further aspect of the inventive subject matter, said client software additionally notifies retailers of the existence of said incentive program.

In a further aspect of the inventive subject matter, said client software additionally provides an event notification, based on said monitoring, to said manufacturer when the inventory of said product is less than a pre-determined target quantity, when said product is out of stock, or when the sales of said product are less than a pre-determined target amount.

In an alternate aspect of the inventive subject matter, said client software additionally forecasts a quantity of product necessary for said promotion incentive program, and orders said quantity of product.

In yet another aspect of the inventive subject matter, said client software additionally reimburses each said retailer for the calculated monetary value of incentives discounted or credited to consumers by said retailer.

In a preferred embodiment, said calculated monetary value is reimbursed to said retailer by a method selected from the group consisting of check, electronic funds transfer, and off- invoice credit.

In another aspect of the inventive subject matter, said client software additionally collects and stores information relating to customer purchasing or transaction history.

In a preferred embodiment, said customer purchasing or transaction history is communicated to said manufacturer.

In a further aspect of the inventive subject matter, said client software additionally collects and stores customer personal data relating to the customer for each customer redemption presented.

In a preferred embodiment, said customer personal data is communicated to said manufacturer.

In an alternate aspect of the inventive subject matter, said parameters additionally include identification of retailers eligible to participate in said program.

In another aspect of the inventive subject matter, said parameters additionally include identification of a geographic area to which said incentive program will apply.

In yet another aspect of the inventive subject matter, said parameters additionally include a maximum monetary value or quantity limit for said incentive program.

### EXAMPLES

The following examples, termed Manufacturer Promotions Use Cases, are illustrative of the inventive subject matter and are not intended to be limitations thereon. The following use cases represent the Manufacturer Promotions functionality and implementation:

1. Future/New Promotions: MGRP U0001. Goal: As shown in Example 1, an authorized Manufacturer user can create a new promotion using web interface triggering subsequent automatically performed tasks by the system necessary to complete a new promotion.

2. Process Pending Promotions: MGRP U0002. Goal: As shown in Example 2, an authorized Manufacturer user can approve a new promotion using web interface triggering subsequent communications mechanism to send emails, faxes, and mails to potential retailers that comes under the market areas defined for the new promotion.

3. Current Promotions: MGRP U0003. Goal: Authorized Manufacturer user can view/modify the details of existing promotions under performance.

4. Past Promotions: MGRP U0004. Goal: Authorized Manufacturer user can view details of past promotions.

5. Retailer Reimbursement Checklists: RRCL U0005. Goal: Authorized Manufacturer user can submit, view/modify, approve, decline reimbursement checklists submitted for a manufacturer promotion.

[image]

[image]

[image]

[image]

[image]

[image]

[image]

[image]

[image]

[image]

[image]

The inventive subject matter being thus described, it will be obvious that the same may be modified or varied in many ways. Such modifications and variations are not to be regarded as a departure from the spirit and scope of the inventive subject matter and all such modifications and variations are intended to be included within the scope of the following claims.

We claim:

1. A method for monitoring retail sales and automatically correlating sold products with manufacturer sponsored or approved promotions presented for redemption by customers, comprising the steps of:
(a) creating a promotion incentive program having parameters relating to at least the following:
(i) identity of a product or service to which the promotion incentive is to apply,
(ii) a price reduction amount of the promotion incentive,
(iii) monetary value, percentage discount, or quantity discount of the promotion incentive, and
(iv) an applicable start date, end date, or both of the incentive program;
(b) providing for incentive program participation acceptance by retailers;
(c) monitoring each incentive discount or credit given by each participating retailer;
(d) calculating the monetary value of each incentive discount or credit given by each participating retailer;
(e) calculating the monetary value of incentives discount or credit to the consumer by each retailer for a selected time period; and
(f) authorizing payment to each retailer for the dollar value of incentives discounted or credited to the consumer for the selected time period.

2. The method of claim 1, comprising the additional step of validating each incentive discount or credit to the consumer by each participating retailer.

3. The method of claim 1, comprising the additional step of providing for modification, continuation, or extension of an existing incentive program.

4. The method of claim 3, wherein the program modification, continuation, or extension is executed by the manufacturer, an authorized supplier or distributor, or an authorized retailer.

5. The method of claim 1, comprising the additional step of notifying retailers of the existence of said incentive program.

6. The method of claim 1, comprising the additional step of providing an event notification, based on said monitoring, to said manufacturer when the inventory of said product is less than a pre-determined target quantity, when said product is out of stock, or when the sales of said product are less than a pre-determined target amount.

7. The method of claim 1, comprising the additional step of forecasting a quantity of product necessary for said promotion incentive program, and ordering said quantity of product.

8. The method of claim 1, comprising the additional step of reimbursing each said retailer for the calculated monetary value of incentives discounted or credited to consumers by said retailer.

9. The method of claim 8, wherein said calculated monetary value is reimbursed to said retailer by a method selected from the group consisting of check, electronic funds transfer, and off-invoice credit.

10. The method of claim 1, comprising the additional step of collecting and storing information relating to customer purchasing or transaction history.

11. The method of claim 1, comprising the additional step of collecting and storing customer personal data relating to the customer for each customer redemption presented.

12. The method of claim 11, wherein said customer personal data is communicated to said manufacturer.

13. The method of claim 1, wherein said parameters additionally include identification of retailers eligible to participate in said program.

14. The method of claim 1, wherein said parameters additionally include identification of a geographic area to which said incentive program will apply.

15. The method of claim 1, wherein said parameters additionally include a maximum monetary value or quantity limit for said incentive program.

16. A method for monitoring retail sales and automatically correlating sold products with manufacturer sponsored or approved promotions presented for redemption by customers, comprising the steps of:
(a) at the request or suggestion of a retailer, supplier, or distributor, creating a promotion incentive program having parameters relating to at least the following:
(i) identity of a product or service to which the promotion incentive is to apply,
(ii) a price reduction amount of the promotion incentive,
(iii) monetary value, percentage discount, or quantity discount of the promotion incentive, and
(iv) an applicable start date, end date, or both of the incentive program;
(b) providing for incentive program participation acceptance by retailers;
(c) monitoring each incentive discount or credit given by each participating retailer;
(d) calculating the monetary value of each incentive discount or credit given by each participating retailer;
(e) calculating the monetary value of incentives discount or credit to the consumer by each retailer for a selected time period; and
(f) authorizing payment to each retailer for the dollar value of incentives discounted or credited to the consumer for the selected time period.

17. A system for monitoring retail sales and automatically correlating sold products with manufacturer sponsored or approved promotions presented for redemption by customers, comprising the following elements, operably connected:
(a) at least one computer having at least one storage medium;
(b) one or more databases residing on said at least one storage medium, in which at least the following data is stored:
(1) the identity of a product or service to which the promotion incentive is to apply,
(2) a price reduction amount of the promotion incentive,
(3) the monetary value, percentage discount, or quantity discount of the promotion incentive, and
(4) an applicable start date and end date of the incentive program; and
(c) client software residing on said at least one storage medium providing an interface to said one or more database (s), wherein the client software identifies users and allows users to be classified into groups, and wherein permissions or roles are assigned to such groups, and wherein:
(i) said software permits creation of a promotion incentive program based on said stored data,
(ii) said software provides for incentive program participation acceptance by retailers,
(iii) said software monitors each incentive discount or credit given by each participating retailer,
(iv) said software calculates the monetary value of each incentive discount or credit given by each participating retailer,
(v) said software calculates the monetary value of incentives discount or credit to the consumer by each retailer for a selected time period, and
(vi) said software authorizes payment to each retailer for the dollar value of incentives discounted or credited to the consumer for the selected time period.

18. The system of claim 17, wherein the client software additionally validates each incentive discount or credit to the consumer by each participating retailer.

19. The system of claim 17, wherein the client software additionally provides for modification, continuation, or extension of an existing incentive program.

20. The system of claim 19, wherein the program modification, continuation, or extension is executed by the manufacturer, an authorized supplier or distributor, or an authorized retailer.

21. The system of claim 17, wherein the client software additionally notifies retailers of the existence of said incentive program.

22. The system of claim 17, wherein the client software additionally provides an event notification, based on said monitoring, to said manufacturer when the inventory of said product is less than a pre-determined target quantity, when said product is out of stock, or when the sales of said product are less than a pre-determined target amount.

23. The system of claim 17, wherein the client software additionally forecasts a quantity of product necessary for said promotion incentive program, and orders said quantity of product.

24. The system of claim 17, wherein the client software additionally reimburses each said retailer for the calculated monetary value of incentives discounted or credited to consumers by said retailer.

25. The system of claim 24, wherein said calculated monetary value is reimbursed to said retailer by a method selected from the group consisting of check, electronic funds transfer, and off-invoice credit.

26. The system of claim 17, wherein the client software additionally collects and stores information relating to customer purchasing or transaction history.

27. The system of claim 26, wherein said customer purchasing or transaction history is communicated to said manufacturer.

28. The system of claim 17, wherein the client software additionally collects and stores customer personal data relating to the customer for each customer redemption presented.

29. The system of claim 28, wherein said customer personal data is communicated to said manufacturer.

30. The system of claim 17, wherein said parameters additionally include identification of retailers eligible to participate in said program.

31. The system of claim 17, wherein said parameters additionally include identification of a geographic area to which said incentive program will apply.

32. The system of claim 17, wherein said parameters additionally include a maximum monetary value or quantity limit for said incentive program.
